(19) United States
(12) Patent Application Publication
(10) Pub. No.: US 2005/0147313 A1
(43) Pub. Date: Jul. 7, 2005

(54) Image deblurring with a systolic array processor

(76) Inventor: Dimitry Gorinevsky, Palo Alto, CA (US)

Correspondence Address: Kris T. Fredrick;Patent Srvices, Honeywell International Inc., 101 Columbia Road, Morristown, NJ, 07962, US

(21) Appl. No.: 10/749,694

(22) Filed: Dec. 29, 2003

(51) Int. Cl. G06K 9/40

(52) U.S. Cl. 382/255; 712/19

(57) ABSTRACT

A method and device for deblurring an image having pixels. A blurred image is downloaded into a systolic array processor having an array of processing logic blocks such that each pixel arrives in a respective processing logic block of one pixel or small groups of pixels. Data is sequentially exchanged between processing logic blocks by interconnecting each processing logic block with a predefined number of adjacent processing logic blocks, followed by uploading the deblurred image. The processing logic blocks provide an iterative update of the blurred image by (i) providing feedback of the blurred image prediction error using the deblurred image and (ii) providing feedback of the past deblurred image estimate. The iterative update is implemented in the processing logic blocks by u(n+1)=u(n)−K*(H*u(n)−y_{b})−S*u(n).

### FIELD OF THE INVENTION

The present invention relates in general to image deblurring and, more particularly, to a method and device which includes an iterative update of the deblurred image estimate, BACKGROUND OF THE INVENTION

Image distortions including noise contamination and blurring are encountered in many imaging applications. The earliest and most advanced applications are associated with astronomical imaging, space earth observations, airborne imaging, and forensic imaging. Deblurring is also a necessary part if the computed tomography imaging algorithms. The blurring might be caused by the imaging system being off-focus, or by the atmospheric distortions. In computer tomography the 3-D image restored through an inverse Radon transform is blurred and need to undergo deblurring. In recent years, the deblurring applications have proliferated into customer imaging devices as well were they can be used for enhancement of static images.

The existing deblurring algorithms and methods require significant computing power and deblurring of high resolution image would take some time even for modern powerful computers. While this processing time delay is often acceptable for deblurring static images, such as astronomical images, it makes it difficult or impossible to enhance streaming images—such as digital video—in real-time, at the frame update rate.

A blurred image is usually considered as a transformation of an ideal image that needs to be restored. This transformation could be described as adding a noise and convolving the ideal image with a Point Spread Function (PSF) of the blur. The PSF describes a spatial intensity pattern that would be observed in the blurred image for a point source in the ideal image. Herein, it is assumed that the PSF is known and spatially invariant n the same across the image.

There are two main classes of approaches to computing the deblurred image given the blur PSF. First class are the frequency domain approaches such as Wiener filter or regularized inversion in frequency domain. These approaches are described in more detail below and entail computation of a Fourier (Cosine) transform of the deblurred image. Applying the inverse Fourier transform then yields the sought deblurred image. The second class includes iterative updates approaches. These include Lucy-Richardson and other updates that iteratively optimize loss indices based on the image statistics. The commonly used iterative update methods are usually localized, in the sense that information from neighborhood pixels only is used to update the deblurred image estimate for a current pixel. The localization enables a parallelized systolic array implementation of the algorithm.

As mentioned above these existing methods work well for static images but are not well suited for real-time deblurring of streaming video. None of them is capable of addressing the entire list and finding a reasonable tradeoff between optimal restoration quality, noise insensitivity, localization, and computational performance.

Some prior art proposals for work with blurred images were developed in the early years of image processing and are very economical in terms of the required computing power and memory access. All of the three methods mentioned below include localized updates. An update for each pixel is based on the data for the pixels in the immediate neighborhood. Such updates can be efficiently implemented through parallel processing using systolic arrays Yet, as will be described below, the known iterative methods have a fundamental deficiency which is addressed by the proposed update.

The three iterative updates described below are most often suggested for use. The first iterative method is the Successive Approximation (Landweber) Method that corresponds to a steepest descent optimization of the quadratic error. It is also known as an iteration with reblurring and has the form:
u(n+1)=u(n)−γH*(H*u(n)−y_{b}
where n is the iteration number, γ is the scalar factor used to adjust the convergence speed and H* is an adjunct operator for H. If H corresponds to a convolution kernel h(−k,l) where * denotes a complex conjugate.

A version of the update is the Van Clittered method which corresponds to the stochastic approximation or least-mean-square update minimizing the same quadratic performance index.
u(n+1)=u(n)−γ(H*u(n)−y_{b}

Both of these updates are linear. A nonlinear update that is supposed to converge faster is the Lucy-Richardson update. While the first shown update above can be considered as a Maximum Likelihood optimization with Gaussian noise model the Lucy-Richardson update is a Maximum Likelihood optimization with a Poisson noise model. Assuming that His normalized to unity, the Lucy-Richardson update can be compactly written in the form

$$u ( n + 1 ) = [ \frac{{y}_{b}}{H * u ( n )} * {H}^{*} ]$$

where the division or fraction inside the big brackets and the multiplication outside of the brackets are pixel-wise operations. The convolutions denoted by * are computed in the usual way.

These updates have two key features relevant to for this invention First, computations in the above equations are localized to the extent that blur PSF operator H is localized. Also, the updates suffer from common problems including slow convergence noise amplification and ‘ringing’ (producing edge artifacts and spurious “sources”). For practical implementation of these updates, stopping the update in time is of foremost importance. The quality of the recovered image is first improved in the update and then starts deteriorating. Stopping an update in time to achieve optimal quality of the recovered image requires supervision and is unacceptable for an embedded implementation in a systolic array processor.

The proposed invention addresses the iterative update convergence issue and, thus, enables an embedded systolic array implementation. The main reason for the eventual divergence of the updates above is that each of these updates converges to the inverse solution as its steady state. The inverse solution is unacceptable because of high frequency noise amplification To achieve good quality of deblurring, there is a need for high-frequency regularization, an optimal trade off between idealized restoration accuracy and noise amplification. deblurring, there is a need for high-frequency regularization, an optimal trade off between idealized restoration accuracy and noise amplification

It would be of great advantage if an iterative update would provide high-frequency regularization.

Another advantage would be if an iterative update would provide an optimal trade off between idealized restoration accuracy and noise amplification.

Other advantages and features will appear hereinafter.

### SUMMARY OF THE INVENTION

This invention proposes a method and device for image deblurring. The proposed method is an iterative update of the deblurred image estimate. The update has two principal terms: (i) feedback of blurred image prediction error using the deblurred image and (ii) feedback of the past deblurred image estimate added to the discrete integrator. The two feedback terms are based on two feedback operators, which are localized FIR convolution operators.

The update feedback operators can de designed with a given degree of localization to provide an optimal tradeoff solution taking into account multiple design objectives including update convergence speed, noise amplification, quality of image restoration, and robustness to operator implementation error. The solution to the operator design problem is computed by Linear Programming (LP) optimization. The update, using the local feedback operators is implemented by using a systolic array processor, where each process can be mass-produced and is capable of simple multiplication and addition operations, as well as communication with the neighbors. With the localized operators, a parallelized implementation of the update algorithms is possible that is completely scalable to very large image sizes. Since the feedback operators are localized, the data exchange necessary to perform the update computations is limited to a neighborhood of each array node processor and computations do not depend on the image size. The proposed update being implemented on an inexpensive systolic processor enables real-time deblurring of high-resolution video images.

### BRIEF DESCRIPTION OF THE DRAWINGS

For a more complete understanding of the invention, reference is hereby made to the drawings, in which:

FIG. 1 is a schematic illustration of a systolic array processor;

FIG. 2 is a plan view of the processor of FIG. 1, showing interconnecting logic blocks;

FIG. 3 is an illustration of an original undistorted image;

FIG. 4 is an illustration of a Gaussian blur operator applied to the image of FIG. 3;

FIG. 5 is an illustration of the optical transfer function of the blur operator of FIG. 4;

FIG. 6 is a an illustration of a blurred image of FIG. 3;

FIG. 7 is a an illustration of a designed symmetric update operator K;

FIG. 8 is a an illustration of a designed symmetric smoothing operator S; and

FIG. 9 is a an illustration of the recovered or deblurred image.

In the figures, like reference characters designate identical or corresponding components and units throughout the several views.

### DETAILED DESCRIPTION OF THE PREFERRED EMBODIMENT

In its simplest form, the present invention provides a method and device for deblurring an image having pixels. A blurred image is downloaded into a systolic array processor having an array of processing logic blocks such that each pixel arrives in a respective processing logic block of one pixel or small groups of pixels. Data is sequentially exchanged between processing logic blocks by interconnecting each processing logic block with a predefined number of adjacent processing logic blocks, followed by uploading the deblurred image. For example if a 1024 by 1024 pixel image is selected, the array may be 256 by 256, thus processing 4 by 4 groups of pixels. Other groups including single pixels, 2 by 2 groups, 3 by 3 groups, and so on may also be processed by the selected systolic array processor.

The processing logic blocks provide an iterative update of the blurred image implemented in the processing logic blocks by u(n+1)=u(n)−K*(H*u(n)−y_{b})−S*u(n) where u is the ideal undistorted image, m and n are column and row indices of an image pixel element, y_{b} (m,n) is the observed blurred image, * denotes a 2D convolution, K is a feedback update operator with a convolution kernel k(m,n) and S is a smoothing operator with a convolution kernel s(m,n).

It is important to distinguish between deblurring algorithm design, which is usually a result or subject of mathematical analysis and its hardware implementation that allows optimized computational performance. In this invention, these two steps are brought closely together such that the very computational structure of algorithms is such as to allow high performance implementation. At the same time, the mathematical analysis and design explicitly take this structure as one of the design constraints.

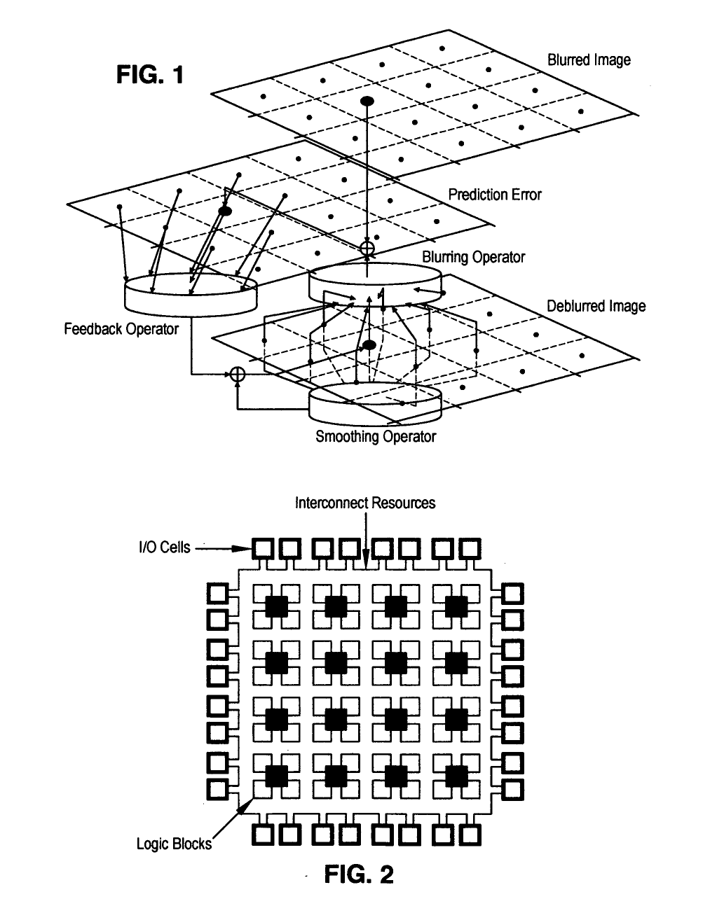

Referring to FIG. 1, data flow in the distributed update u(n)+1)=u(n)−K*(H*u(n)−y_{b})−S*u(n) shows how each pixel the intermediate data in the update is stored in three planes: the blurred image y_{b}, the current deblurred image estimate u, and the prediction error H*u−y_{b}. The update uses data from a localized neighborhood of each pixel in each of the three planes.

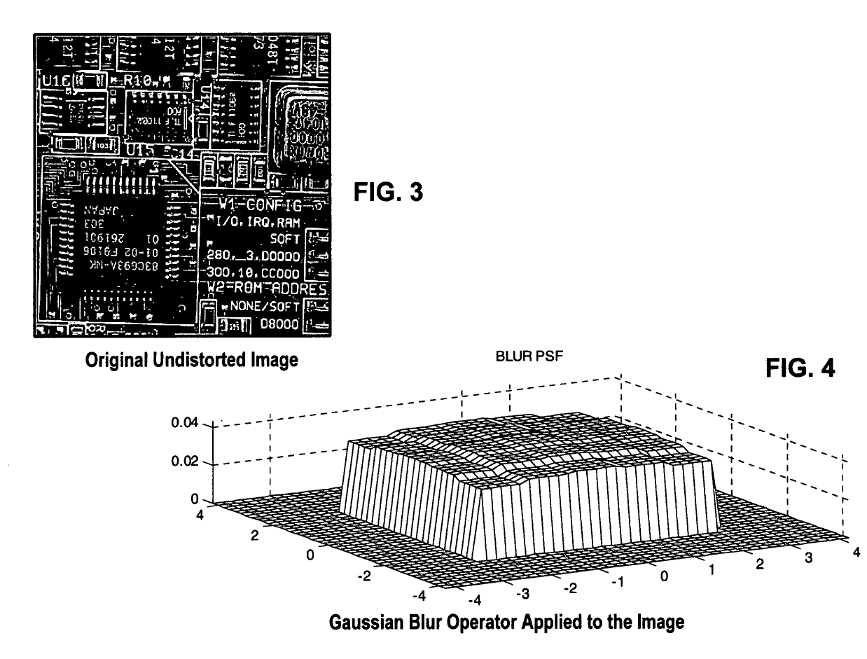

The update u(n+1)=u(n)−K*(H*u(n)−y_{b})−S*u(n) is amenable to a systolic array processor implementation. Such processor illustrated in FIG. 2 consists of an array of simple processing elements (logic blocks), one per image pixel The processing logic blocks are interconnected such that each can exchange data with its immediate neighbors. Each of the processing logic blocks also has some local data memory and is capable of simple arithmetic operations such as addition, subtraction, and multiplication. Using the interconnect logic, the blurred image can be downloaded into the processor array, each pixel into a respective processing logic block. By sequentially exchanging data with the nearest neighbors, each logic block can accumulate data from any predefined number of neighbors within certain reach. Of course this would require multiple update cycles, a larger number of cycles for a larger reach.

By accumulating the data within the reach demanded by the localized spatial operators in the update above for each pixel can be implemented within the respective processor. This presumes preloading and storing the operators H, K, and S in each of the array processing logic blocks. For each pixel the computations are extremely simple and require a number of additions, subtractions, and multiplications, proportional to the size (squared reach) of the FIR operators H, K, and S Apart from the data transfer associated with downloading the blurred image and uploading the deblurred image estimate, the computational demand on each of the processing logic blocks does not at all depend on the image size. Of course, the overall amount of computations grows linearly with the image size. These computations are, however, performed in parallel by the processing logic blocks of the array. For large array size, an overall computational power of the described specialized parallel computer implemented by the systolic array could be very substantial. The data transfer requirements grow very slowly, as a square root of the image pixel size. Thus, the proposed approach is fully scalable and can be implemented at a very high speed for high resolution video images. Even for inexpensive systolic array processor, it is possible to do a few dozen update iterations within a video frame update time.

The update above can be considered implementing a spatial 2-D IIR filter. This 2D IIR filter allows satisfying design requirements much better than a FIR filter with the same number of spatial tap delays. The above described use of a systolic array processor to implement the 2-D IIR filter can be considered as an extension of well-known practice of using shift registers and summer/adder logic in high-performance hardware implementations of standard time-domain digital filters. The additional complexity in this invention is caused by dealing with 2-D signals (images) that are iterated in time.

The design of localized FIR operators K and S herein closely follows the approach of [8], where feedback design for a distributed control problem is considered. The update u(n+1)=u(n)−K*(H*u(n)−y_{b})−S*u(n) is a recursive filter estimating the 2-D input signal u from the noisy blurring system output data. It is well known that estimation problems in linear systems theory are dual to control problems and the same mathematical tools can be applied to both The FIR feedback operators K and S in u(n+1)=u(n)−K*(H*u(n)−y_{b})−S*u(n) are assumed to have the same symmetry properties as the blur operator H. In the basic case of central (2-fold) symmetry, these operators can be presented in the form
k(λ₁ λ₂)=kₒ+Σkₘₙ(λ^{m}₁λⁿ₂+λ−^{m}₁λ⁻ⁿ₂),
s(λ₁λ₂)=sₒ+]sₘₙ(λ^{m}₁λⁿ₁+λ−^{m}₁λ⁻ⁿ₁),
where kₒ, kₘₙ, Sₒ, sₘₙ are the design parameters and the summation in these equations is performed over all indices covering a given vicinity of the zero spatial shift A rectangular support set of the FIR operators might consists of all indices such that 0<m<N, /n/<N or m=0, 0<m<N.

Respective relationships can be written down in the case of a 4-fold or 8-fold symmetry. As an example, in case of a 8-fold symmetry the operator K has the form
k(λ₁ λ₂)=kₒ+Σkₘₙ(λ^{m}₁λⁿ₂+λ−^{m}₁+λ⁻ⁿ₂+λ−^{m}₁λⁿ₂+λ^{m}₁+λ⁻ⁿ₂+λⁿ₁λ^{m}₂+λ−ⁿ₁+λ^{-m}₂+λ⁻ⁿ₁λ^{m}₂+λν₁λ^{-m}₂),
Collecting all the independent weights of the two FIR operators yields the design parameter vector
x=[kₒ . . . kₒ . . . kₘₙ . . . sₒ . . . Sₘₙ . . . ]

This vector should be chosen such that the system transfer functions satisfy requirements the above equations.

By substituting 80 ₁=e^{vi}₁, λ₂=e^{iv}₂ into the above equations, one can notice that all three optical transfer functions k~(v₁ vₛ₎)s~(v₁ vₛ₎) and h~(v₁ vₛ₎) are real. The functions k~(v₁ vₛ₎)s~(v₁vₛ₎) and k~(v₁ vₛ₎)h~(v₁ vₛ₎) are also linear in the design parameter vector. Another key fact is that the denominator is always real positive. Being affine in x this denominator can be presented in the form
s~(v₁ vₛ₎)+k~(v₁ vₛ₎)h~(v₁ vₛ₎)=c^{r}(v₁ vₛ₎)xc^{r}(v₁ vₛ₎)x 0, v₁ vₛ₎∈

[symbol]

The last inequality follows from the requirement which can be presented in the form
131 r₀≦c^{r}(v₁ vₛ)x≦1+r₀

The design constraints and other design specifications that one might wish to consider for this problem can be presented in the form

$$\vert \frac{{c}^{r} ( {v}_{1} {v}_{s} ) x + b ( {v}_{1} {v}_{s} ) x}{{c}^{r} ( {v}_{1} {v}_{s} ) x} \vert$$

By using this denominator positively, this can be written as
−c^{r}(v₁ vₛ₎)x≦a^{r}(v₁ vₛ₎)x+b(v₁ vₛ₎)≦c^{r}(v₁ vₛ₎)x

For controller design, these inequalities can be complemented by a requirement that the integrator leakage operator S is possibly small. Small operator S improves the image recovery performance. The latter requirement can be presented in the form
|Rₓ|≦x₀, x₀→min.
where the matrix R selects the last half of the components of x, ones that contain the weights of the smoothing operator S The absolute value above is component-wise and xₒ is a scalar. The linear inequalities of the form of the denominator following from the design constraints as well as can be solved by gridding the spatial frequencies {x₁, x₂}. By adding the requirement and augmenting the design vector x with the parameter x₀we have a Linear Programming (LP) problem. The LP problem even of a very large size (for a dense grid in v₁, v₂) can be solved efficiently and reliably with help of modern interior point solvers. In the example below a LINPROG solver from Matlab Optimization Toolbox was used.

In the event that the image that is to be deblurred is a color image, the update equation is slightly different Specifically, for a color image, y_{b}=y_{d}(j,k,c) where c denotes the color. For instance, the color mmay be ‘r’, ‘g’ or ‘b’ and y_{b}=y_{d}(j,k,c) is the intensity of the color c at the pixel with the coordinates (j,k,). For an hyperspectral image, there might be many more thhan three ‘colors’ ir waavelengths in the image. For a color image, the update has the same form as above for each color and can be written in the form such that the iterative update is implemented in the processing logic blocks by u(n+1; c)=u(n, c)−K*(H*u(n, c)−y_{b}(c))−S*u(n,c) where y_{b}(c)=y_{d}(j,k,c) is the 2-D array of color c intensities for the blurred image encompassing all pixels (j,k) in the image and u(n, c)=u(j,k,n,c) is the 2-D array of color c intensities for the restored image estimates at iteration number n. The image u(n, c) is an array that includes all pixels (j,k).

### EXAMPLE AND ILLUSTRATION

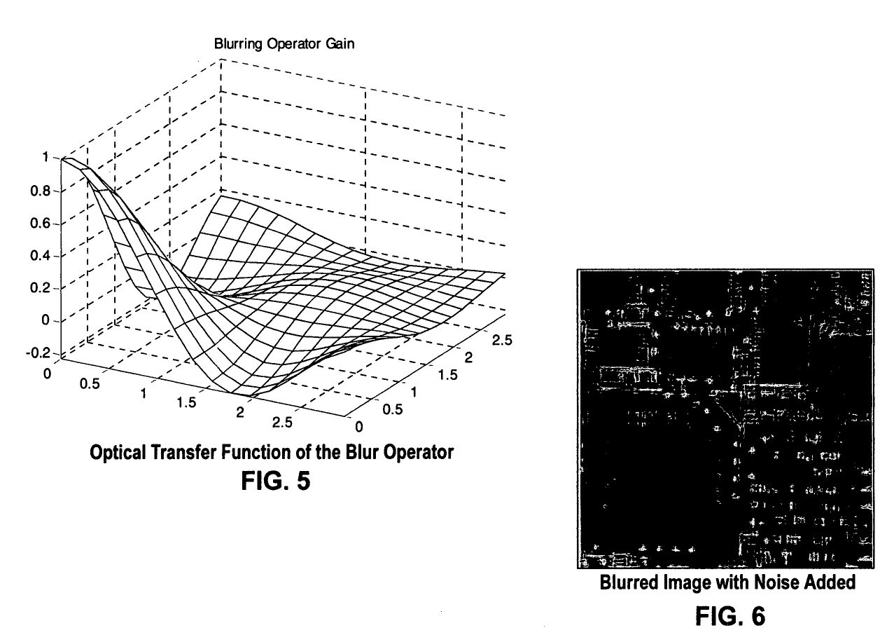

The image in FIG. 3 was distorted with a localized Gaussian blur operator H with a PSF illustrated in FIG. 4. This PSF is a FIR operator with maximal N=3 spatial offset taps on each side for each of the two spatial dimensions. The optical transfer function h~(v₁ vₛ₎) of the blur in FIG. 3 is displayed in FIG. 5. The original image of FIG. 3 was blurred with the operator H in FIG. 4 and a random noise e with a maximum magnitude 0.02 was added. The blurred and noisy image y_{b} is shown in FIG. 6.

The feedback operators S and K have been designed as described in the previous section. The design assumed FIR operators with N=3 maximal spatial offset and 8-fold symmetry (the operator H has 8-fold symmetry). The following parameters have been used in the design:
the convergence rate was chosen as r₀=0.08
the recovery error bound was chosen as u₀=0.3
the image noise bound was chosen as dₒ=0.08
the in-band domain B was chosen as a set of spatial frequencies such that h~(v₁ vₛ)≦h₀, where h₀=0.185

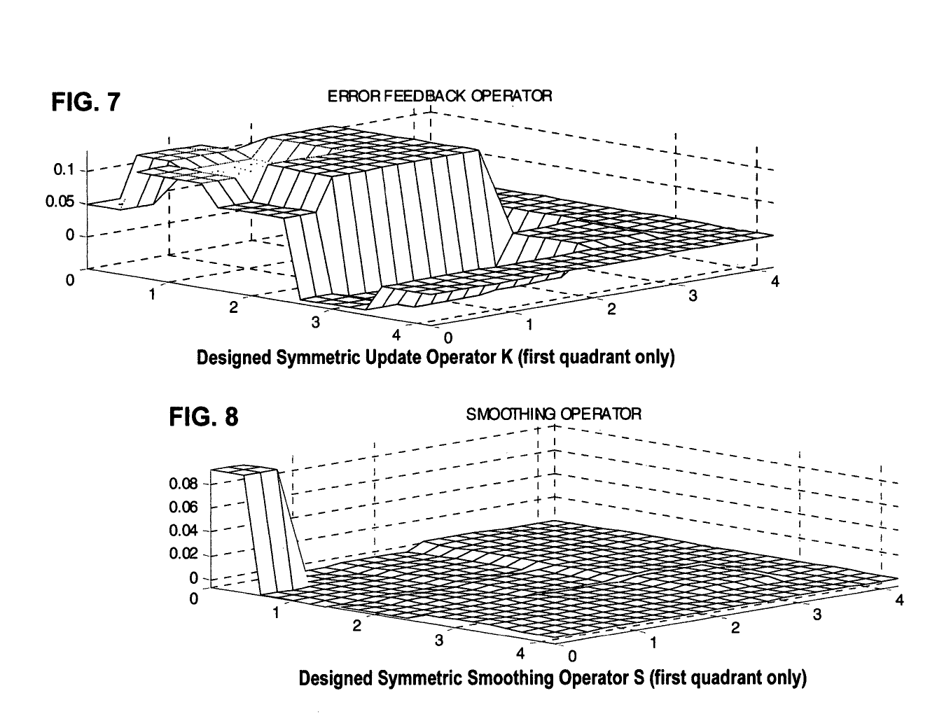

The design resulted in the feedback operators K and S illustrated in FIGS. 7 and 8 respectively. Because of the 8-fold symmetry, only a first quadrant (nonnegative offsets) is shown.

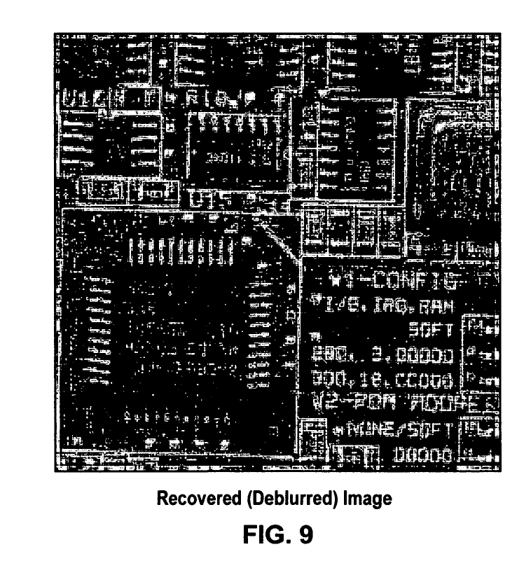

The recovered image was obtained by applying 30 steps of the update with designed operators K and S and the known blur operator H to the image y_{b} shown in FIG. 6. The recovered image is displayed in FIG. 9. As one can see the recovery quality is quite good. The original and blurred image were taken from Matlab Image Processing Toolbox demo illustrating the use of a Lucy-Richardson algorithm. The image in FIG. 9 has somewhat better recovery quality than one obtained by the Lucy-Richardson algorithm in the Matlab demo. The fundamental difference however is that run further unchecked, the update continues (slightly) improving the recovery quality, while continuing the Lucy-Richardson update leads to the restored image deterioration because of the high-frequency noise increase and ringing that become increasingly noticeable.

This invention makes possible fast real-time deblurring with help of inexpensive hardware. This enables a host of applications with customer-grade imaging devices such as: scanners, photocopiers, cameras, and various streaming video devices. As one example, security video or other remote camera video might be slightly off focus with no possibility of focusing the remote camera This video could be enhanced by deblurring.

While particular embodiments of the present invention have been illustrated and described, they are merely exemplary and a person skilled in the art may make variations and modifications to the embodiments described herein without departing from the spirit and scope of the present invention. All such equivalent variations and modifications are intended to be included within the scope of this invention, and it is not intended to limit the invention, except as defined by the following claims.

1. A method of deblurring an image, comprising the steps of.
downloading a blurred image having pixels into a systolic array processor, said processor comprising an array of processing logic blocks such that groups of pixel arrive in respective processing logic blocks;
sequentially exchanging data between processing logic blocks by interconnecting each processing logic block with a predefined number of the processing logic blocks adjacent thereto; and
uploading the deblurred image.

2. The method of claim 1, wherein said processing logic blocks providing an iterative update of said blurred image by (i) providing feedback of the blurred image prediction error using the deblurred image and (ii) providing feedback of the past deblurred image estimate.

3. The method of claim 1, wherein said iterative update is implemented in said processing logic blocks by u(n+1)=u(n)−K*(H*u(n)−y_{b})−S*u(n) where u is the ideal undistorted image, m and n are column and row indices of an image pixel element, y_{b}(m,n) is the observed blurred image, * denotes a 2-D convolution, K is a feedback update operator with a convolution kernel k(m,n) and S is a smoothing operator with a convolution kernel s(m,n).

4. The method of claim 1, wherein said iterative update is implemented in said processing logic blocks by u(n+1; c)=u(n, c)−K*(H*u(n, c)−y_{b}(c))−S*u(n,c) where y_{b}(c)=y_{d}(j,k,c) is the 2-D array of color c intensities for the blurred image encompassing all pixels (j,k) in the image and u(n, c)=u(j,k,n,c) is the 2-D array of color c intensities for the restored image estimates at iteration number n.

5. The of claim 1, wherein said processor groups pixel in groups that comprises at least one pixel.

6. The method of claim 5, wherein said groups of pixels comprises a group selected from 2 by 2 pixels, 3 by 3 pixels, and 4 by 4 pixels.

7. A device for deblurring an image, comprising:
an blurred image source having pixels;
a systolic array processor adapted to download said blurred image, said processor comprising an array of processing logic blocks such that groups of pixels arrive in respective processing logic blocks;
said processor being adapted to sequentially exchange data between processing logic blocks by interconnecting each processing logic block with a predefined number of the processing logic blocks adjacent thereto; and
said processor including an upload for the deblurred image.

8. The device of claim 7, wherein said processor is adapted to process logic blocks to provide an iterative update of said blurred image by (i) providing feedback of the blurred image prediction error using the deblurred image and (ii) providing feedback of the past deblurred image estimate.

9. The device of claim 7, wherein said processor includes an iterative update implemented in said processing logic blocks by u(n+1)=u(n)−K*(H* u(n)−y_{b})−S*u(n) where u is the ideal undistorted image, m and n are column and row indices of an image pixel element, y_{b}(m,n) is the observed blurred image, * denotes a 2-D convolution, K is a feedback update operator with a convolution kernel k(m,n) and S is a smoothing operator with a convolution kernel s(m,n).

10. The device of claim 9, wherein the operators H, K, and S are preloaded in each of the array processing logic blocks.

11. The device of claim 7, wherein said iterative update is implemented in said processing logic blocks by u(n+1; c)=u(n, c)−K*(H*u(n, c)−y_{b}(c))−S*u(n,c) where y_{b}(c)=y_{d}(j,k,c) is the 2-D array of color c intensities for the blurred image encompassing all pixels (j,k) in the image and u(n, c)=u(j,k,n,c) is the 2-D array of color c intensities for the restored image estimates at iteration number n.

12. The device of claim 7, wherein said processor groups pixel in groups that comprises at least one pixel.

13. The device of claim 12, wherein said groups of pixels comprises a group selected from 2 by 2, 3 by 3 and 4 by 4 pixels.

14. A device for deblurring an image, comprising:
image means for providing a blurred image having pixels;
systolic array processor means for processing said blurred image and adapted to download said blurred image, said processor means comprising an array of processing logic block means for processing groups of pixels in respective processing logic blocks;
said processor means being adapted to sequentially exchange data between processing logic block means by interconnecting each processing logic block means with a predefined number of the processing logic block means adjacent thereto; and
said processor means including means for uploading the deblurred image.

15. The device of claim 14, wherein said processor means is adapted to process logic blocks to provide an iterative update of said blurred image by (i) providing feedback of the blurred image prediction error using the deblurred image and (ii) providing feedback of the past deblurred image estimate.

16. The device of claim 15, wherein said processor includes means an iterative update implemented in said processing logic block means by u(n+1)=u(n)−K*(H*u(n)−y_{b})−S*u(n) where u is the ideal undistorted image, m and n are column and row indices of an image pixel element, y_{b}(m,n) is the observed blurred image, * denotes convolution, K is a feedback update operator with a convolution kernel k(m,n) and S is a smoothing operator with a convolution kernel s(m,n).

17. The device of claim 16, wherein the operators H, K, and S are preloaded in each of the array processing logic blocks.

18. The device of claim 15, wherein said iterative update is implemented in said processing logic blocks by u(n+1; c)=u(n, c)−K*(H*u(n, c)−y_{b}(c)−S*u(n,c) where y_{b}(c)=y_{d}(j,k,c) is the 2-D array of color c intensities for the blurred image encompassing all pixels (j,k) in the image and u(n, c)=u(j,k,n,c) is the 2-D array of color c intensities for the restored image estimates at iteration number n.

19. The device of claim 14, wherein said processor groups pixel in groups that comprises at least one pixel.

20. The device of claim 19, wherein said groups of pixels comprises a group selected from 2 by 2, 3 by 3 and 4 by 4 pixels.
